(19) United States
(12) Patent Application Publication
(10) Pub. No.: US 2012/0102385 A1
(43) Pub. Date: Apr. 26, 2012

(54) DETERMINING HEIGHTS OF TABLE CELLS

(75) Inventor: Tim Prebble, Longmont, CO (US)

(73) Assignee: KONICA MINOLTA SYSTEMS LABORATORY INC., San Mateo, CA (US)

(21) Appl. No.: 12/911,281

(22) Filed: Oct. 25, 2010

(51) Int. Cl. G06F 17/00

(52) U.S. Cl. 715/227

(57) ABSTRACT

A method for managing tables, including: obtaining a document including a table having a bottom row and a first stacked row; identifying, within the first stacked row, a first plurality of neutral cells having an initial height value; calculating, using a layout engine, a plurality of overall vertical dimensions for the first plurality of neutral cells based on a plurality of data items in the first plurality of neutral cells; identifying a maximum overall vertical dimension (MOVD) of the plurality of overall vertical dimensions; setting, in response to the MOVD exceeding the initial height value, a plurality of height attributes of the first plurality of neutral cells to the MOVD; shifting down the bottom row by a first difference between the MOVD and the initial height value; and rendering a page of the document including the table after shifting down the bottom row.

### BACKGROUND

An electronic document (ED) may have any number of pages with one or more tables. The ED may specify the number of rows, the number of columns, the initial/default cell (or row) heights, the initial/default cell (or column) widths, and the merge attributes (i.e., row span, column span) of each cell in the table. The ED may also identify the one or more data items (i.e., text, images, shapes, etc.) contained within the cells of a table.

The final height (i.e., displayed height or printed height) of a cell in a table is based on: (1) the initial or default height, if any, as specified by ED; (2) the merge attributes of the cell, as specified by the ED; (3) the heights of other cells in the same row; and (4) the dimensions and positions of the data items (i.e., text, images, shapes, etc.) contained in the cells. Although the dimensions of shapes, graphics, and images are usually specified by the ED, exactly how these shapes, graphics, and images affect the overall sizes of the cells which contain them depends on how they are positioned (i.e., laid out) within their respective cells. Further, as the dimensions of laid out text is a function of the font type, font size, font style, the algorithms used by the layout engine, etc., the ED does not fully specify the dimensions of the laid out text.

It is the responsibility of a page rendering device (PRD) to layout the table(s) as specified by the ED. Accordingly, when calculating the final height of a cell, the PRD must consider items (1)-(4). However, as item (4) is not entirely specified in the ED (discussed above), it must be determined using some other means and then used in conjunction with items (1)-(3) in order that the cell and table as a whole be properly rendered.

### SUMMARY OF INVENTION

In general, in one aspect, the invention relates to a method for managing tables. The method comprises: obtaining a document comprising a table having a bottom row and a first stacked row; identifying, within the first stacked row, a first plurality of neutral cells having an initial height value; calculating, using a layout engine, a plurality of overall vertical dimensions for the first plurality of neutral cells based on a plurality of data items in the first plurality of neutral cells; identifying a maximum overall vertical dimension (MOVD) of the plurality of overall vertical dimensions; setting, in response to the MOVD exceeding the initial height value, a plurality of height attributes of the first plurality of neutral cells to the MOVD; shifting down the bottom row by a first difference between the MOVD and the initial height value; and rendering a page of the document comprising the table after shifting down the bottom row.

In general, in one aspect, the invention relates to a non-transitory computer readable storage medium storing instructions for managing tables. The instructions comprise functionality to: obtain a document comprising a table having a bottom row and a first stacked row; identify, within the first stacked row, a first plurality of neutral cells having an initial height value; calculate, using a layout engine, a plurality of overall vertical dimensions for the first plurality of neutral cells based on a plurality of data items in the first plurality of neutral cells; identify a maximum overall vertical dimension (MOVD) of the plurality of overall vertical dimensions; set, in response to the MOVD exceeding the initial height value, a plurality of height attributes of the first plurality of neutral cells to the MOVD; shift down the bottom row by a first difference between the MOVD and the initial height value; and render a page of the document comprising the table after the bottom row is shifted down.

In general, in one aspect, the invention relates to a system for managing tables. The system comprises: a hardware processor; a memory operatively connected to the hardware processor; and a plurality of instructions stored on the memory and comprising functionality to: obtain a document comprising a table having a bottom row and a first stacked row; identify, within the first stacked row, a first plurality of neutral cells having an initial height value; calculate, using a layout engine, a plurality of overall vertical dimensions for the first plurality of neutral cells based on a plurality of data items in the first plurality of neutral cells; identify a maximum overall vertical dimension (MOVD) of the plurality of overall vertical dimensions; set, in response to the MOVD exceeding the initial height value, a plurality of height attributes of the first plurality of neutral cells to the MOVD; shift down the bottom row by a first difference between the MOVD and the initial height value; and render a page of the document comprising the table after the bottom row is shifted down.

Other aspects of the invention will be apparent from the following description and the appended claims.

### BRIEF DESCRIPTION OF DRAWINGS

FIG. 1 shows a block diagram of a system for determining the heights of cells in accordance with one or more embodiments of the invention.

FIG. 2 shows example tables and cells in accordance with one or more embodiments of the invention.

FIGS. 3 and 4 show flowcharts of methods for determining the heights of cells in accordance with one or more embodiments of the invention.

FIG. 5 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a system and method for determining the heights of cells in a table. A cell's height is based on the initial or default height of the cell, as specified by an ED; the merge attributes, especially row span, of the cell; the heights of other cells in the same row as the cell; and the dimensions of any data item contained within the cell. The dimensions of the data item may be calculated using a layout engine and then used with the other factors to determine the height of the cell.

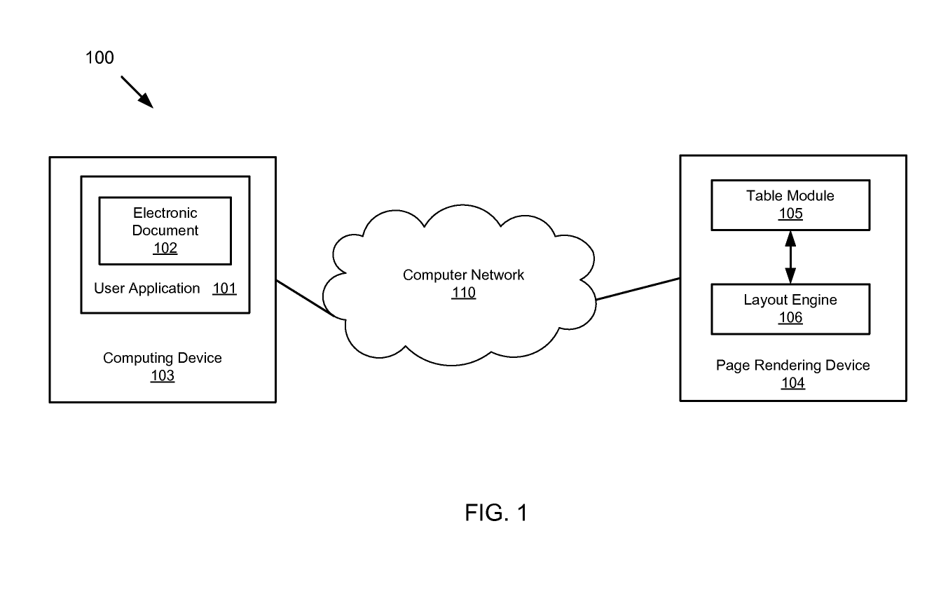

FIG. 1 shows a system (100) in accordance with one or more embodiments of the invention. As shown in FIG. 1, the system (100) has multiple components including a PRD (104) and a computing device (103). The PRD (104) may be, for example, a printer, an electronic reader, etc. The computing device (103) may be a personal computer (PC), a desktop computer, a mainframe, a server, a telephone, a kiosk, a cable box, a personal digital assistant (PDA), a mobile phone, a smart phone, etc. There may be a direct connection (e.g., universal serial bus (USB) connection) between the computing device (103) and the PRD (104). Alternatively, the computing device (103) and the PRD (104) may be connected using a network (110) having wired and/or wireless segments.

In one or more embodiments of the invention, the PRD (104) is located on the computing device (103). In such embodiments, the PRD (104) may correspond to any combination of hardware and software on the computing device (103) for rendering page of an ED.

In one or more embodiments of the invention, the computing device (103) executes the user application (101). The user application (101) is a software application operated by a user and configured to obtain, input, generate, display and/or print the ED (102). Accordingly, the user application (101) may be a word-processing application, a spreadsheet application, a desktop publishing application, a graphics application, a photograph printing application, an Internet browser, etc. The user application (101) may generate new EDs and/or obtain previously saved EDs. In one or more embodiments of the invention, the ED (102) includes one or more tables (discussed below).

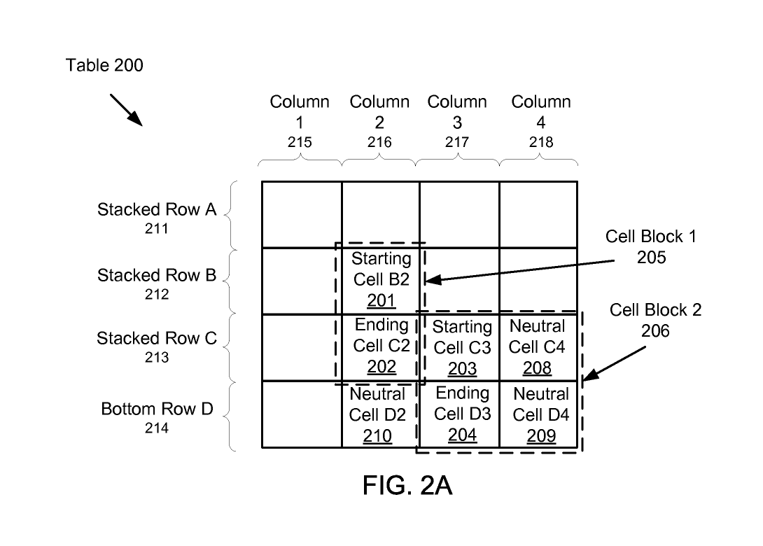

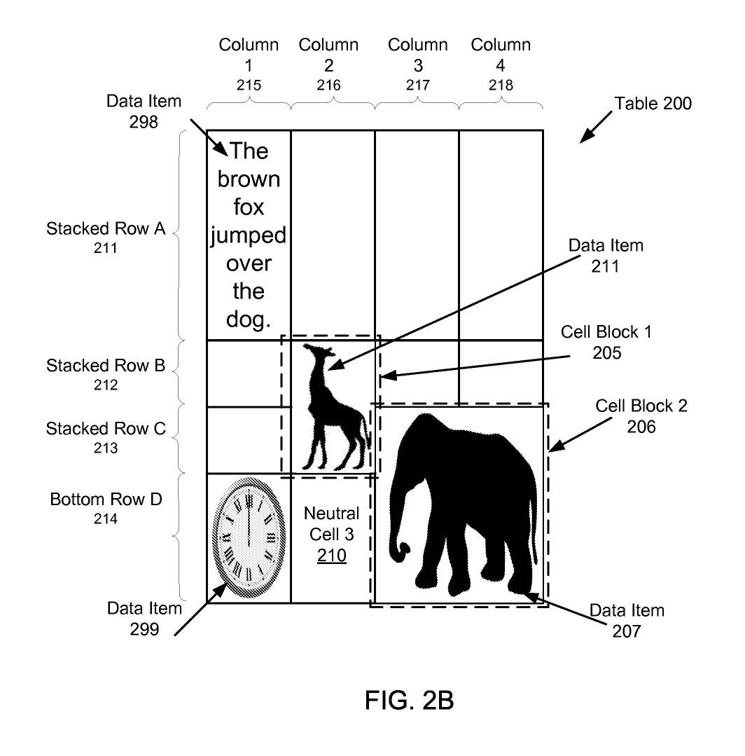

FIG. 2A shows a table (200) in accordance with one or more embodiments of the invention. The table (200) may be a table specified by an ED (e.g., ED (102) discussed above in reference to FIG. 1). As shown in FIG. 2A, the table (200) includes the bottom row D (214) and multiple rows (i.e., Stacked Row A (211), Stacked Row B (212), Stacked Row C (213)) positioned on top of the bottom row D (214). The table (200) also includes one or more columns (i.e., Column 1 (215), Column 2 (216), Column 3 (217), and Column 4 (218)). The intersection of a row (211, 212, 213, 214) and a column (215, 216, 217, 218) is referred to as a cell. Further, each cell may be uniquely identified by a row letter and column number. For example, cell A1 is the top left cell in the table (200). Similarly, cell D4 is the bottom right cell in the table (200).

As shown in FIG. 2A, the table (200) includes 16 cells. In one or more embodiments of the invention, the attributes of each cell, row, column, and/or table are specified in the ED. Cell attributes include the initial or default height and width of the cell, the position (i.e., coordinates) of the cell, the row span and column span of the cell (discussed below), the data item(s) in the cell, etc. Similarly, row attributes include the height and the position of the row, and column attributes include the width and the position of the column. Those skilled in the art, having the benefit of this detailed description will appreciate that by specifying the some attributes of a row or column, the attributes of the cells in the row or column may become redundant. For example, the initial or default height of a cell may correspond to the row height of the row having the cell. Accordingly, if the row height is specified, the initial or default height of the cell is known without being separately specified.

In one or more embodiments of the invention, a single cell can span multiple rows and/or columns effectively covering the existing cells within the multiple rows and/or columns. In such embodiments, the single cell is effectively merged with the existing cells, and the number of rows/columns spanned by the single cell is specified by the merge attributes (i.e., row span, column span) of the single cell. In one or more embodiments of the invention, the single cell and the covered existing cells are referred to as a “cell block.” The single cell is referred to as the “starting cell” of the cell block, while the existing cell that is both in the last row of the cell block and horizontally aligned with the starting cell is referred to as the “ending cell” of the cell block. In one or more embodiments of the invention, the attributes of an existing cell within a cell block can be set independently of the starting cell. However, the contents of the existing cell(s) may be covered by the content of the starting cell.

As shown in FIG. 2A, cells B2 and C2 form the cell block 1 (205). B2 (201) is the staring cell of the cell block 1 (205). Accordingly, the merge attributes of cell B2 specify the row span (i.e., 2) and column span (i.e., 1) of cell B2. Further, as C2 (202) is both in the last row of the cell block 1 (205) and horizontally aligned with the starting cell B2 (201), cell C2 (202) is the ending cell of the cell block 1 (205).

As yet another example, as shown in FIG. 2A, cell C3 (203), cell C4 (208), cell D3 (204), and cell D4 (209) form the cell block 2 (206). Cell C3 (203) is the starting cell of the cell block 2 (206). Accordingly, the merge attributes of the cell C3 (203) specify the row span (i.e., 2) and the column span (i.e., 2) of the cell C3 (203). Further, as D3 (204) is both in the last row of the cell block 2 (206) and horizontally aligned with the starting cell C3 (230), cell D3 (204) is the ending cell of the cell block 2 (206). Both the starting cell B2 (201) and the starting cell C3 (203) correspond to the top and leftmost cells in their respective cell blocks (205, 206).

In one or more embodiments of the invention, all cells in the table (200) except the starting cells (201, 203), are referred to as neutral cells (e.g., neutral cell D2 (210), neutral cell C4 (208), neutral cell D4 (209), etc.). In such embodiments of the invention, the ending cells (202, 204) are a special type of neutral cell.

FIG. 2B shows the table (200) in accordance with one or more embodiments of the invention. As shown in FIG. 2B, one or more cells in the table (200) contain data items (e.g., text, images, etc.). For example, cell A1 has the data item (298), cell D1 has the data item (299), starting cell B2 has the data item (211), and starting cell C3 has the data item (207). As also shown in FIG. 2A, the data item (211) in the starting cell B2, and the data item (207) in the starting cell C3, cover the contents of the other cells in the cell blocks (205, 206).

Although the dimensions of shapes, graphics, and images are usually specified by the ED, exactly how these shapes, graphics, and images affect the overall sizes of the cells which contain them depends on how they are positioned (i.e., laid out) within their respective cells. Further, as the dimensions of laid out text is a function of the font type, font size, font style, the algorithms used by a layout engine, etc., the ED does not fully specify the dimensions of the laid out text. Accordingly, the height, width, and/or positioning of a data item (207, 211, 298, 299) may affect the height and/or width of the cell containing the data item. Thus, in some cases, the height and/or width of the cell may need to be increased (i.e., set to a higher value) to accommodate the positioned (i.e., laid out) data item and correctly display/print the data item

In one or more embodiments of the invention, the ED (102) is represented/defined using a document markup language (e.g., ODF, OOXML, etc.). Accordingly, the attributes of the table, rows, columns, and/or cells (i.e., number of rows, number of columns, heights, widths, row spans, column spans, data items, etc.) in the ED (102) may be specified using tags of the document markup language. Moreover, these properties/attributes are needed to correctly render the ED (102) for displaying or printing.

In one or more embodiments of the invention, the PRD (104) includes a layout engine (106). The layout engine (106) is configured to calculate the positions and sizes of the table, columns, rows, cells, and data items on a conceptual page (e.g., paper, transparencies, microfilm, region on a computer monitor displaying a page image, e-book reader, etc.). In one or more embodiments of the invention, the layout engine (106) is configured to calculate the vertical dimension (i.e., height), horizontal dimension (i.e., width), and position (i.e., coordinates) of a data item contained within a cell of a table. Accordingly, the layout engine (106) may be needed to determine the correct size of a cell in order for the data item within the cell to be rendered properly.

In one or more embodiments of the invention, the PRD (104) includes the table module (105). The table module (105) is configured to identify, from the ED (102), and record (e.g., in a data structure) the attributes of the table, rows, columns, cells, and/or data items specified by the ED. In one or more embodiments of the invention, the table module (105) calculates new values and/or records updated values (e.g., calculated by the layout engine (106)) for one or more of the attributes.

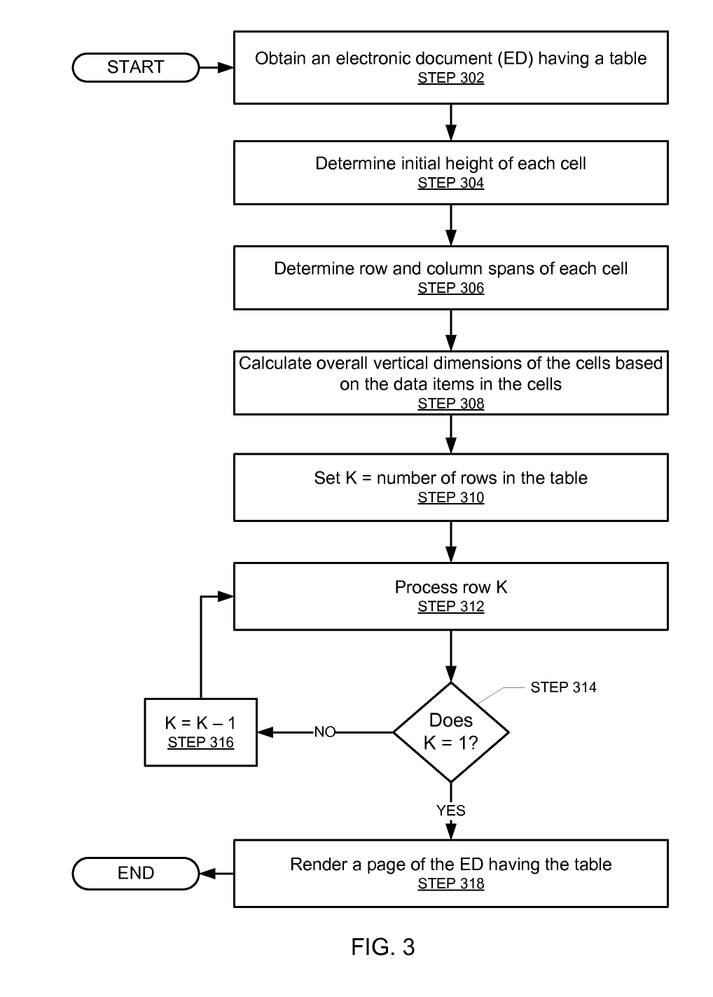

FIG. 3 shows a flowchart of a method in accordance with one or more embodiments of the invention. The process depicted in FIG. 3 may be used to render a page of the ED having a table. Further, the process depicted in FIG. 3 may be implemented using the system (100), described above in reference to FIG. 1. One or more steps shown in FIG. 3 may be omitted, repeated, and/or performed in a different order among different embodiments of the invention. Accordingly, embodiments of the invention should not be considered limited to the specific number and arrangement of steps shown in FIG. 3.

Initially, an ED having a table is obtained (STEP 302). The ED may be represented/defined using a document markup language (e.g., ODF, OOXML, etc.). Accordingly, the attributes of the table, rows, columns, and/or cells (i.e., number of rows, number of columns, heights, widths, row spans, column spans, data items, etc.) in the ED may be specified using tags of the document markup language.

In STEP 304, the initial or default height values of the cells are determined. The initial height values may be recorded as attributes of the cells in the ED. In one or more embodiments of the invention, the initial height value of each cell in a row corresponds to the height of the row.

In STEP 306, the row span and column span of each cell is determined. As discussed above, a neutral cell in the table occupies one row and one column. In contrast, a staring cell in the table is effectively merged with (i.e., spans) cells in neighboring rows and/or columns. In one or more embodiments of the invention, the row span and column span of a cell are identified from the merge attributes of the cell. Accordingly, the starting cells and the neutral cells of the table are identified by examining the merge properties of the cells. Also, the height of each starting cell must be increased such that the cell extends to the bottom of its ending cell.

In STEP 308, the overall vertical and horizontal dimensions of the cells are calculated based on the data items in the cells. As discussed above, a data item may correspond to text, an image, a graphic, or any combination thereof. As also discussed above, although the dimensions of shapes, graphics, and images are usually specified by the ED, exactly how these shapes, graphics, and images affect the sizes of the cells which contain them depends on how they are positioned (i.e., laid out) within their respective cells. Further, as the dimensions of laid out text is a function of the font type, font size, font style, the algorithms used by the layout engine, etc., the ED does not fully specify the dimensions of the laid out text. Accordingly, a layout engine (e.g., layout engine (106), discussed above in reference to FIG. 1) is used to position (i.e., layout) the data items and calculate the overall vertical and horizontal dimensions for each cell.

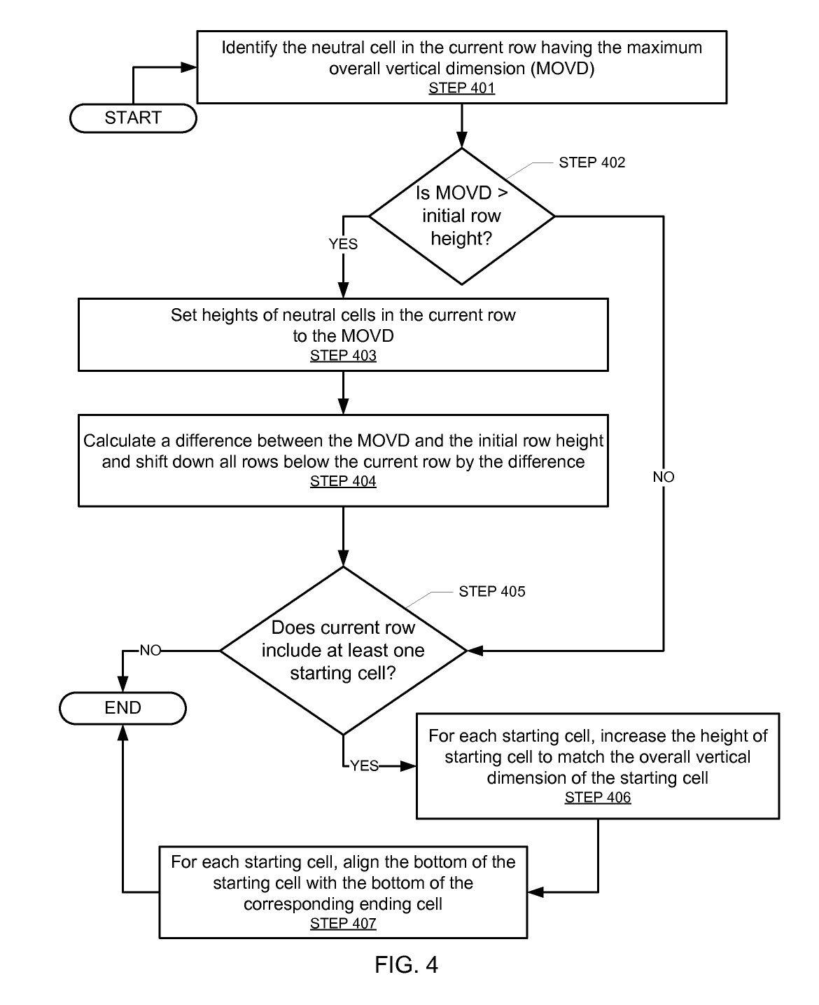

In STEP 310, the variable K is set to the number of rows in the table. In STEP 312, row K is processed. In other words, the dimensions and the positions of each cell in the table are calculated. The processing of a row is discussed in FIG. 4. In STEP 314 it is determined whether K=1. When it is determined that K=1, the process proceeds to STEP 318. However, when it is determined that K < >1 (i.e., K is not equal to 1), the process proceeds to STEP 316, where K is decremented, and then returns to STEP 312. Those skilled in the art, having the benefit of this detailed description, will appreciate that STEPS 310, 312, 314, and 316 force the last row of the table to be processed first, then the second-last row, then the third-last row, etc., until the first row is processed.

In STEP 318, the page with the table is rendered based on the calculated positions and sizes of the cells. Accordingly, the page may be displayed (i.e., on an e-reader or monitor) or printed (i.e., on paper, a microfiche, etc.).

FIG. 4 shows a flowchart of a method in accordance with one or more embodiments of the invention. The process depicted in FIG. 4 may be used to process a row of a table (i.e., STEP 312 in FIG. 3). Accordingly, the process depicted in FIG. 4 may be executed multiple times for a table. Further, the process depicted in FIG. 4 may be implemented using the system (100), described above in reference to FIG. 1. One or more steps shown in FIG. 4 may be omitted, repeated, and/or performed in a different order among different embodiments of the invention. Accordingly, embodiments of the invention should not be considered limited to the specific number and arrangement of steps shown in FIG. 4.

Initially, the neutral cell in the current row having the largest (i.e., maximum) overall vertical dimension (MOVD) is identified (STEP 401). As noted above, a neutral cell may be distinguished from a staring cell within the table based on the merge attributes (e.g., row span, column span) of the cell. As also noted above, the overall vertical and horizontal dimensions of a cell may be calculated by positioning (i.e., laying out) the data item(s) (i.e., text, graphic, etc.) in the cell using a layout engine. Accordingly, the MOVD is identified by comparing the calculated overall vertical dimensions of all the neutral cells in the row, and selecting the neutral cell having the largest overall vertical dimension.

As noted above, the initial height values of all cells in the row, as specified in the ED, are typically the same and may be specified as the initial row height. In STEP 402, it is determined whether the MOVD exceeds the initial row height of the current row. When it is determined that the MOVD exceeds the initial row height, the process proceeds to STEP 403. Otherwise, when it is determined that the MOVD does not exceed the initial row height, the process proceeds to STEP 405.

In STEP 403, the heights of all neutral cells in the current row are set to the MOVD. In other words, the height attribute of all neutral cells in the current row are set (i.e., updated) to the MOVD.

In STEP 404, the difference between the initial row height for the current row and the MOVD is calculated. Then, all rows below the current row are shifted down by the calculated difference. In one or more embodiments of the invention, the position attributes of all cells in all rows below the current row are increased by the calculated difference. Those skilled in the art, having the benefit of this detailed description, will appreciate that STEP 404 may be omitted when the current row is the bottom row of the table.

In one or more embodiments of the invention, if a neutral cell in a row below the current row is an ending cell of a cell block, the height of the corresponding starting cell is increased to align the bottom of the starting cell with the bottom of the ending cell.

In STEP 405, it is determined whether the current row includes at least one starting cell. When it is determined that the current row includes at least one starting cell, the process proceeds to STEP 406. Otherwise, when it is determined that the current row has no starting cells, the process ends. As noted above, the starting cell of a cell block may be identified based on the merge attributes of the cell.

In STEP 406, for each starting cell in the current row, the height of the starting cell is set to the overall vertical dimension of the starting cell, if it exceeds the current height of the starting cell. As discussed above, the overall vertical dimension of starting cell may be calculated using a layout engine and is based on the data item(s) in the starting cell.

In STEP 407, for each starting cell in the current row, the bottom of the starting cell is aligned with the bottom of the corresponding ending cell in the cell block. In one or more embodiments of the invention, the alignment includes calculating a difference from the bottom of the ending cell to the bottom of the starting cell in the current row. If the calculated difference is zero, no alignment is needed. If the calculated difference exceeds zero, then the height of the starting cell is increased to align the bottom of the starting cell with the bottom of the ending cell.

If the calculated difference is less than zero, the heights of all cells in the same row as the ending cell are increased by the absolute value of the calculated difference (i.e., |calculated difference|). Further, for each cell that is (1) in the same row as the ending cell; and (2) an ending cell in another cell block (“cell block X”), the height of the starting cell of cell block X is increased to align the bottom of the starting cell of cell block X with the bottom of the ending cell. Then, all rows below the row having the ending cell are shifted down by the calculated difference (i.e., similar to STEP 404).

Embodiments of the invention have one or more of the following advantages: the ability to render tables with cells having data items of various dimensions; the ability to consider the initial/default height of a cell, the merge properties of the cell, the heights of other cells in the same row, and the vertical dimensions of data items in the cell when rendering the table having the cell; etc.

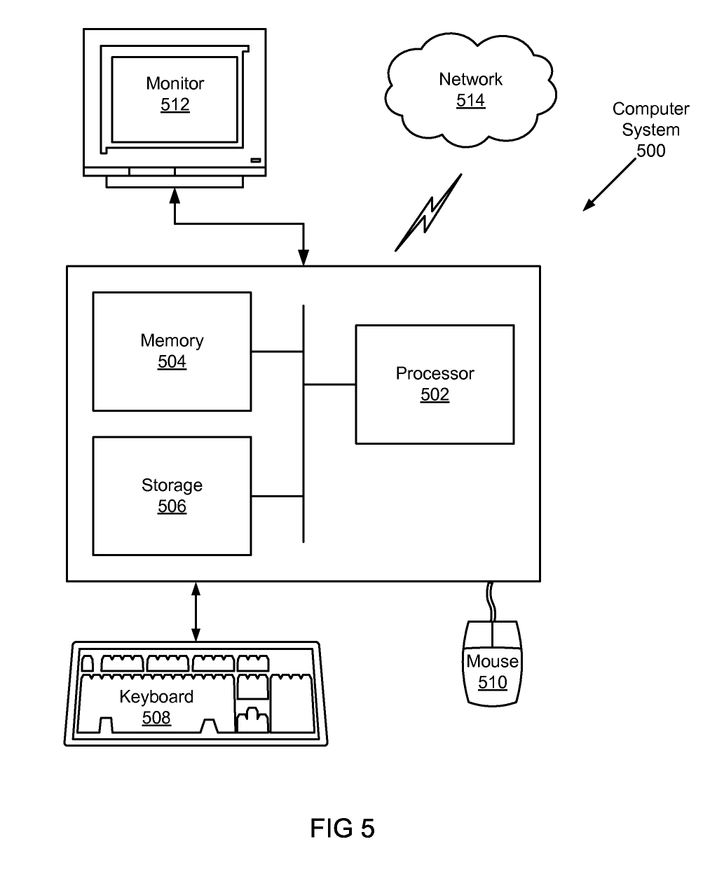

Embodiments of the invention may be implemented on virtually any type of computer regardless of the platform being used. For example, as shown in FIG. 5, a computer system (500) includes one or more hardware processor(s) (502) (such as a central processing unit (CPU), integrated circuit, etc.), associated memory (504) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities typical of today's computers (not shown). The computer system (500) may also include input means, such as a keyboard (508), a mouse (510), or a microphone (not shown). Further, the computer system (500) may include output means, such as a monitor (512) (e.g., a liquid crystal display (LCD), a plasma display, or cathode ray tube (CRT) monitor) or audio speakers (not shown). The computer system (500) may be connected to a network (514) (e.g., a local area network (LAN), a wide area network (WAN), the Internet, or any other type of network) via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, in one or more embodiments of the invention, one or more elements of the aforementioned computer system (500) may be located at a remote location and connected to the other elements over a network. Further, embodiments of the invention may be implemented on a distributed system having a plurality of nodes, where each portion of the invention (e.g., computing device (103), PRD (104), etc.) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed is:

1. A method for managing tables, comprising:
obtaining a document comprising a table having a bottom row and a first stacked row;
identifying, within the first stacked row, a first plurality of neutral cells having an initial height value;
calculating, using a layout engine, a plurality of overall vertical dimensions for the first plurality of neutral cells based on a plurality of data items in the first plurality of neutral cells;
identifying a maximum overall vertical dimension (MOVD) of the plurality of overall vertical dimensions;
setting, in response to the MOVD exceeding the initial height value, a plurality of height attributes of the first plurality of neutral cells to the MOVD;
shifting down the bottom row by a first difference between the MOVD and the initial height value; and
rendering a page of the document comprising the table after shifting down the bottom row.

2. The method of claim 1, further comprising:
identifying, within a second stacked row, a plurality of vertical positions of a second plurality of neutral cells; and
modifying the plurality of vertical positions by the first difference before shifting down the bottom row,
wherein the second stacked row is located between the first stacked row and the bottom row in the table.

3. The method of claim 2, further comprising:
identifying, within the second stacked row, an ending cell of a cell block; and
aligning a bottom of a starting cell of the cell block with a bottom of the ending cell before shifting down the bottom row.

4. The method of claim 1, wherein shifting down the bottom row comprises:
identifying, within the bottom row, a plurality of vertical positions of a second plurality of neutral cells; and
modifying the plurality of vertical positions by the first difference.

5. The method of claim 1, further comprising:
identifying, within the first stacked row, a starting cell of a cell block;
setting, before calculating the plurality of overall vertical dimensions, a height attribute of the starting cell to a height of the cell block; and
aligning, after shifting down the bottom row, a bottom of the starting cell with a bottom of an ending cell of the cell block.

6. The method of claim 5, further comprising:
calculating, using the layout engine, an overall vertical dimension of the starting cell based on a data item in the starting cell;
setting, in response to the overall vertical dimension exceeding the height of the cell block, the height attribute of the starting cell to the overall vertical dimension of the starting cell.

7. The method of claim 5, wherein the ending cell is located within the bottom row.

8. The method of claim 5, wherein the ending cell is located within a second stacked row, and wherein the second stacked row is located in the table between the first stacked row and the bottom row.

9. The method of claim 5, wherein aligning the bottom of the starting cell comprises:
calculating a second difference between the bottom of the starting cell and the bottom of the ending cell;
increasing the height attribute of the staring cell by the second difference.

10. The method of claim 5, wherein aligning the bottom of the starting cell comprises:
calculating a second difference between the bottom of the starting cell and the bottom of the ending cell; and
increasing a height attribute of the ending cell by the second difference.

11. A non-transitory computer readable storage medium storing instructions for managing tables, the instructions comprising functionality to:
obtain a document comprising a table having a bottom row and a first stacked row;
identify, within the first stacked row, a first plurality of neutral cells having an initial height value;
calculate, using a layout engine, a plurality of overall vertical dimensions for the first plurality of neutral cells based on a plurality of data items in the first plurality of neutral cells;
identify a maximum overall vertical dimension (MOVD) of the plurality of overall vertical dimensions;
set, in response to the MOVD exceeding the initial height value, a plurality of height attributes of the first plurality of neutral cells to the MOVD;
shift down the bottom row by a first difference between the MOVD and the initial height value; and
render a page of the document comprising the table after the bottom row is shifted down.

12. The non-transitory computer readable storage medium of claim 11, the instructions further comprising functionality to:
identify, within a second stacked row, a plurality of vertical positions of a second plurality of neutral cells; and
modify the plurality of vertical positions by the first difference before shifting down the bottom row,
wherein the second stacked row is located between the first stacked row and the bottom row in the table.

13. The non-transitory computer readable storage medium of claim 12, the instructions further comprising functionality to:
identify, within the second stacked row, an ending cell of a cell block; and
align a bottom of a starting cell of the cell block with a bottom of the ending cell before shifting down the bottom row.

14. The non-transitory computer readable storage medium of claim 11, the instructions further comprising functionality to:
identifying, within the first stacked row, a starting cell of a cell block;
setting, before calculating the plurality of vertical dimensions, a height attribute of the starting cell to a height of the cell block; and
aligning, after shifting down the bottom row, a bottom of the starting cell with a bottom of an ending cell of the cell block.

15. The non-transitory computer readable storage medium of claim 14, the instructions further comprising functionality to:
calculate, using the layout engine, an overall vertical dimension of the starting cell based on a data item in the starting cell;
set, in response to the overall vertical dimension exceeding the height of the cell block, the height attribute of the starting cell to the overall vertical dimension of the starting cell.

16. The non-transitory computer readable storage medium of claim 14, wherein the instructions to align the bottom of the starting cell comprise functionality to:
calculate a second difference between the bottom of the starting cell and the bottom of the ending cell;
increase the height attribute of the staring cell by the second difference.

17. The non-transitory computer readable storage medium of claim 14, wherein the instructions to align the bottom of the starting cell comprise functionality to:
calculate a second difference between the bottom of the starting cell and the bottom of the ending cell; and
increase a height attribute of the ending cell by the second difference.

18. A system for managing tables, comprising:
a hardware processor;
a memory operatively connected to the hardware processor; and
a plurality of instructions stored on the memory and comprising functionality to:
obtain a document comprising a table having a bottom row and a first stacked row;
identify, within the first stacked row, a first plurality of neutral cells having an initial height value;
calculate, using a layout engine, a plurality of overall vertical dimensions for the first plurality of neutral cells based on a plurality of data items in the first plurality of neutral cells;
identify a maximum overall vertical dimension (MOVD) of the plurality of overall vertical dimensions;
set, in response to the MOVD exceeding the initial height value, a plurality of height attributes of the first plurality of neutral cells to the MOVD;
shift down the bottom row by a first difference between the MOVD and the initial height value; and
render a page of the document comprising the table after the bottom row is shifted down.

19. The system of claim 18, the plurality of instructions further comprising functionality to:
identify, within a second stacked row, a plurality of vertical positions of a second plurality of neutral cells; and
modify the plurality of vertical positions by the first difference before shifting down the bottom row,
wherein the second stacked row is located between the first stacked row and the bottom row in the table.

20. The system of claim 19, the plurality of instructions further comprising functionality to:
identify, within the second stacked row, an ending cell of a cell block; and
align a bottom of a starting cell of the cell block with a bottom of the ending cell before shifting down the bottom row.

21. The system of claim 18, the plurality of instructions further comprising functionality to:
identifying, within the first stacked row, a starting cell of a cell block;
setting, before calculating the plurality of vertical dimensions, a height attribute of the starting cell to a height of the cell block; and
aligning, after shifting down the bottom row, a bottom of the starting cell with a bottom of an ending cell of the cell block.

22. The system of claim 21, the plurality of instructions further comprising functionality to:
calculate, using the layout engine, an overall vertical dimension of the starting cell based on a data item in the starting cell;
set, in response to the overall vertical dimension exceeding the height of the cell block, the height attribute of the starting cell to the overall vertical dimension of the starting cell.

23. The system of claim 21, the plurality of instructions further comprising functionality to:
calculate a second difference between the bottom of the starting cell and the bottom of the ending cell;
increase the height attribute of the staring cell by the second difference.

24. The system of claim 21, wherein the instructions to align the bottom of the starting cell comprise functionality to:
calculate a second difference between the bottom of the starting cell and the bottom of the ending cell; and
increase a height attribute of the ending cell by the second difference.
